(19) United States
(12) Patent Application Publication
(10) Pub. No.: US 2004/0034667 A1
(43) Pub. Date: Feb. 19, 2004

(54) Incorporating data into files

(76) Inventors: Pierre Sauvage, Notre Dame de Commiers (FR); Benoit Minster, Ismier (FR)

Correspondence Address: LOWE HAUPTMAN GILMAN & BERNER, LLP, Suite 310, 1700 Diagonal Road, Alexandria, VA, 22314, US

(21) Appl. No.: 10/375,051

(22) Filed: Feb. 28, 2003

(30) Foreign Application Priority Data
Mar. 4, 2002 (EP) 02354039.6

(51) Int. Cl. G06F 7/00

(52) U.S. Cl. 707/200; 707/2

(57) ABSTRACT

Electronic media files, particularly different versions of the same files having embedded data, are identified using embedded data. Data are embedded in the files in such a way as to allow subsequent extraction of the embedded data using a general purpose scan facility.

### FIELD OF INVENTION

The present invention relates to a method of and apparatus for incorporating or embedding user data into electronic files and, more particularly, to techniques for incorporating such data in media files so as to allow subsequent extraction of the user data using a general purpose scan facility.

### BACKGROUND ART

Computer systems comprise many hundreds or thousands of electronic files that define and determine the functionality of the computer system. In such systems there exists a strong requirement to be able to accurately identify computer files, for example so that existing files can be replaced or updated as required.

Computer file systems generally enable files to have a file name and a file type identifier that identifies the format of the file. Additionally, some file systems also provide some limited additional data, such as the date the file was created or the date of the last modification. Although the file creation date can be used to identify a difference between two files having the same name and the same extension, in order to identify the version of a particular file it is necessary to manually cross-reference such information with a corresponding list of known versions and known creation dates. Furthermore, the file creation date or file modification dates can be easily changed without affecting the contents of the file, further hindering version identification. Consequently, file systems alone do not generally provide adequate file identification mechanisms.

In the field of digital rights management (DRM), media files are securely identified through the use of watermarking. Watermarking typically enables the detection or prevention of unauthorized copying and distribution of media and other files, and can also be employed for file authentication purposes. Watermarking involves embedding complex security data in a file in such a way that the presence of the security data is not detectable in the binary data of the file whereby the unauthorized detection and tampering of the watermark is extremely difficult. In addition, the presence of the watermark must not be human perceptible upon playback or viewing of a media file.

In image files, for example, watermarks are generally embedded by making small changes to, for example, certain luminance values such that the watermark data is embedded into the file without changing the human perception of the image represented by the file. Complex algorithms are used to determine where and how such watermarking data is embedded in order to meet the dual constraints of avoiding visual detection and avoiding machine detection in the binary file data. Watermarks are also developed to be particularly robust and to remain extractable even if, for example, files are resampled, resized, changed from one format to another and so on.

Consequently, the use of watermarking generally requires complex and often proprietary algorithms for inserting watermark data into and for extracting watermark data from media files.

In some operating systems general purpose scan facilities are provided for extracting embedded identification data from files. In Hewlett-Packard UX and UNIX systems, for example, a command known as the ‘WHAT’ command is used to scan and analyze the binary data of files and search for a pair of known delimiting sequences which bound a user data string. If the delimiting sequences are found, the user data string bound thereby is output and displayed to the user. The combination of the delimiting sequences and the user data string is herein referred to as a ‘WHAT’ string. The user data string is typically used for version control information, although its usage is not limited thereto.

The ‘WHAT’ command is primarily intended for use in source code control systems (SCCS) to enable version identification and tracking of files in software development environments. A ‘WHAT’ string can be incorporated into a C language file source file by inserting (for example using a text editor) the following line into an appropriate place in the source code:

char ident[ ]=“@(#) Version 1.3.2>”;

A text editor places the above-line at a suitable position in the file, thereby allowing the version of the file to be subsequently determined through use of the ‘WHAT’ command. Since the inserted line is also a valid C construct, the ‘WHAT’ string is also present in an object code file resulting from the compilation of the C source file. In this case a compiler determines the position of the ‘WHAT’ string within the object code file.

One aim of the present invention is to provide a new and improved method of and apparatus for incorporating a user data string into media files in a way which does not involve the complexity or the overhead of watermarking techniques. This technique thereby enables the nature, content or version of such media files to be determined other than by listening to or viewing the files, preferably through use of a universal scan facility such as the ‘WHAT’ command.

### SUMMARY OF THE INVENTION

According to a first aspect of the present invention a data sequence including an identification sequence bounded by predetermined delimiters is inserted in a media file by determining a position where the data sequence can be incorporated into the file to take into account the human perception of the incorporated data sequence upon playback or viewing of the file. The data sequence is incorporated into the file at the determined position thereby allowing the subsequent output of the identification sequence by a general purpose scan facility (such as the ‘WHAT’ command) that (1) is capable of recognizing the delimiters and (2) acts to output the identification sequence irrespective of the file format or file content outside of the delimiters.

Insertion of the data sequence as stated has the advantage of enabling user data strings to be incorporated in media files, and allows use of existing general purpose scan facilities, such as the ‘WHAT’ command, for subsequent extraction of the incorporated user data string. Furthermore, the inclusion of the user data string does not unduly affect the intended use of the files.

Preferably the step of incorporating the data sequence is achieved by replacing an existing data sequence in the file with the data sequence.

The position can also be determined by calculating, for each position in the file, the energy difference of the data sequence to be incorporated and the corresponding data sequence to be replaced in the file and choosing the position where the data sequence is to be replaced according to the calculated energy values.

The step of determining can also comprise modifying the identification sequence to be incorporated in such a way as to change the binary value of the data sequence without changing the information conveyed thereby and calculating, for the modified data sequence, and for each position in the file, the energy difference of the modified data and the corresponding data sequence to be replaced in the file.

Preferably the general purpose scan facility is the ‘WHAT’ command, and the delimiting sequences comprise at least one of the ASCII sequences: @(#), ″, > and new-line.

The invention is particularly suited for use with media files that are substantially error-tolerant. The type of media files include audio, video or image files.

According to yet a further aspect, a data sequence is embedded into a file such that the position where the data is embedded in the file takes into account human perception of the presence of the embedded data, and wherein the embedded data sequence is clearly identifiable within the binary data of the file, to allow subsequent extraction of the data sequence by a general purpose scan facility.

In a still further aspect, a substantially error-tolerant media file is post-processed to incorporate a data sequence in a media file, wherein the data sequence comprises an identification sequence bounded by predetermined delimiters. A position is thus determined where the data sequence can be incorporated into the file to take into account the human perception of the incorporated data sequence upon playback or viewing of the file and the data sequence is incorporated at the determined position. This allows the subsequent output of the identification sequence by a general purpose scan facility capable of recognizing the delimiters and that acts to output the identification sequence irrespective of the file format or file contents outside of the delimiters.

Another aspect of the invention concerns an article of manufacture comprising a memory storing computer readable program code embodied therein for enabling a computer to perform a method of incorporating a data sequence in a media file, wherein the data sequence comprises an identification sequence bounded by predetermined delimiters. The computer readable program code in the memory includes computer readable program code for causing the computer to determine a position where the data sequence can be incorporated into the file to take into account the human perception of the incorporated data sequence upon playback or viewing of the file.

Also provided is a memory storing computer readable program code for causing the computer to incorporate the data sequence at the determined position, thereby allowing the subsequent output of an identification sequence by a general purpose scan facility capable of recognizing the delimiters and that acts to output the identification sequence irrespective of the file format or file contents outside of the delimiters.

The present invention takes advantage of the fact that some files, particularly media files, are generally error-tolerant in nature. For example, the “.raw” audio file format, includes data which is a direct representation of a real audio signal. If the data in the file is changed, the corresponding audio signal generated when playing the file through an appropriate audio player will differ from that of the original signal. Nevertheless, an audio signal may still be generated despite of the errors or changes which have been introduced into the original data.

In other media file formats, such as MPEG video files, video data is stored in a compressed format having a complex structure of error correction codes, interleaving, frames and so on. Such formats are commonly designed to be error tolerant and are resistant, to a reasonable extent, to noise or errors in the data. For example, if data in the file is changed so that the data contains errors or noise the video file can still be playable by a media player even though noise or other artifacts are displayed during playback.

By contrast, many other file formats, such as object code files, are not error-tolerant, and any errors introduced to the data in such files are likely to render such files unusable. With object code files the data in the file represents precise assembly language instructions which define the program the object code represents. Consequently, even minor changes to the data in the file can prevent correct execution of the program or even cause the program to crash.

Error-tolerant files, such as media files, are therefore generally suitable for embedding user data strings therein through post-processing techniques, whilst non-error tolerant files, such as object code files and word processing documents, must generally only be changed by the application that was used to create them.

The present invention takes advantage of this characteristic of media files to embed user data strings into such media files, for example, for the purpose of subsequent file identification. The embedding can be achieved, for example, through post-processing of the file or can be included, for example, as part of media file generation or editing applications.

### BRIEF DESCRIPTION OF THE DRAWING

Embodiments of the invention will now be described, by way of example, with reference to the accompanying diagrams, in which:

FIG. 1 is a flow diagram outlining the main processes performed by a computer according to a first embodiment of the present invention; and

FIG. 2 is a diagram representing a file and a data sequence to be incorporated into the file.

### DETAILED DESCRIPTION OF THE DRAWING

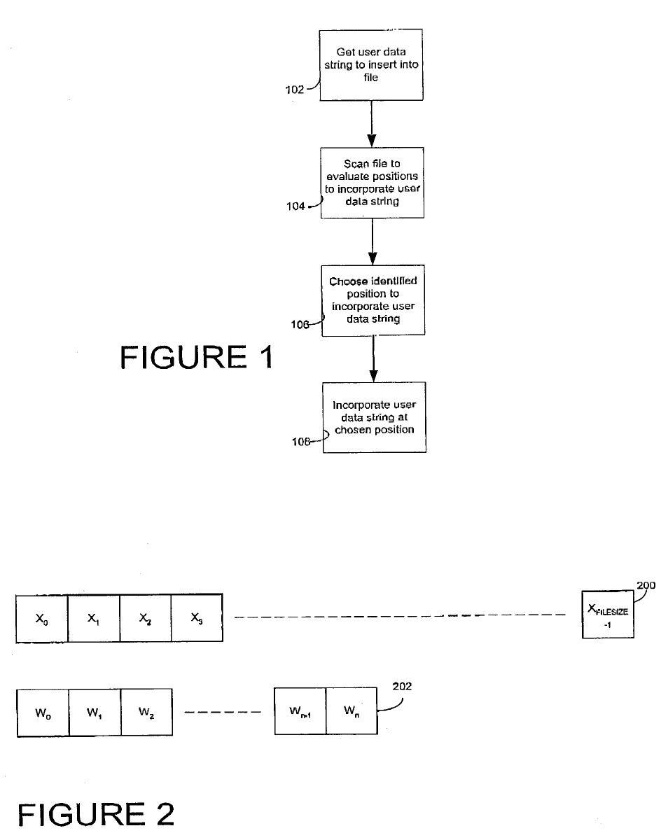

Below is described an embodiment, with reference to FIGS. 1 and 2, in which a computer and general purpose scan facility (not shown) process a file to incorporate user data strings therein, for example, for allowing the subsequent identification of the user data string for file identification purposes.

In a first step, 102, the computer obtains the user data string that is to be incorporated or embedded into the file through a user interface, text file or other appropriate means. The computer combines the user data string with known binary delimiting sequences, for example, such as those used in the ‘WHAT’ command, to allow subsequent extraction of a user data string by a general purpose scan facility, such as the known ‘WHAT’ command. As described previously, the combination of the delimiting sequences and the user data string is herein referred to as a ‘WHAT’ string. The delimiters used by the ‘WHAT’ command comprise a first, initiating delimiting sequence comprising the ASCII characters @(#), and a second, terminating delimiting sequence which comprises either an ASCII ″, >, new-line, \, or null character. Obviously, other delimiting sequences can be used depending on the general purpose scan facility required to subsequently extract the user data string.

The general purpose scan facility then scans the file into which the ‘WHAT’ string is to be incorporated (step 104) to evaluate the positions where the ‘WHAT’ string can be incorporated into the file. Once the evaluation step is complete, the position at which to incorporate the ‘WHAT’ string is chosen (step 106) and the ‘WHAT’ string is incorporated into the file at that position (step 108).

One way the scan facility evaluates the positions where the ‘WHAT’ string can be incorporated into the file is described below, with reference to FIG. 2.

A ‘WHAT’ string 202 is to be incorporated into file 200 that comprises a number of bytes of information, X₀ to X_{FILESIZE-1}; the ‘WHAT’ string data 202 comprises (n+1) bytes W₀ to Wₙ.

It is preferable that the ‘WHAT’ string 202 replace existing data in the file 200 in such a way that the presence of the ‘WHAT’ string does not substantially affect human perception upon playback or viewing, as appropriate, of the file. In order to minimize any undesirable effects it is important to carefully determine the position where the ‘WHAT’ string is to be embedded in the file.

One way to achieve this is for the computer to (1) calculate an approximation of total energy difference resulting from incorporating the ‘WHAT’ string at different positions within the file, and (2) mathematically determine the position that should have the least impact in terms of human perception.

This can be achieved, for example, by the computer calculating the following equation:

E=(xᵢ−w₀)²+(xᵢ₊₁−w₁)² . . . +(xᵢ₊ₙ−wₙ)² 0<i<Filesize−n

where:

E=approximation of total energy difference

Xᵢ=the value of byte i in the file

Wᵢ=the value of byte i in the ‘WHAT’ string

The computer solves this equation for values of i from i=0 up to i=Filesize−n

In this way, the computer calculates the effect of incorporating the ‘WHAT’ string at every position within the file. Subsequently, the computer selects the position which corresponds to the lowest energy difference between the original file data and the ‘WHAT’ string as the position in file 200 where the ‘WHAT’ string is to be inserted. It should be appreciated, however, that it is not always possible to incorporate a ‘WHAT’ string into a file without causing some adverse effects during playback or viewing of the file.

One advantage of the present embodiment is that minor changes in the ‘WHAT’ string are usually placed in the same place in the file. For example, if an initial ‘WHAT’ string of, say, “@(#)OCMP V1.3” is incorporated into the file using the above described method, a subsequent user string of “@(#)OCMP V1_{—}4.” will overwrite the initial user data string since the energy approximation difference is small.

The length of the ‘WHAT’ string is not limited, although it will be appreciated that shorter 'WHAT strings are less likely to be human perceptible upon playback of the file.

The preferred way of incorporating a ‘WHAT’ string into a file is by replacing existing data, although those skilled in the art will appreciate that insertion is possible in certain circumstances. Care, however, needs to be taken when using insertion since, for example, in the case of audio files, insertion has the effect of increasing the length of the audio content of the file.

To further reduce the possibility of a human perceiving the incorporation of the ‘WHAT’ string in the original file, additional measures can be taken to attempt to improve the matching between the ‘WHAT’ string and the data which is to be replaced by the ‘WHAT’ string.

The additional measures include modifying the ASCII representation of the user data string, without changing the context or content of the user data string. For example, text can be changed from uppercase to lowercase, spaces can be changed to full stops or hyphens, and so on.

For example, if the user data string specified by a user is ‘Version 3.0.0’, the ASCII representation could be changed, for example, to ‘VerSION-3-0.0’. This substantially changes the binary representation of the user data string, but does not affect the actual information conveyed thereby. In this way it is possible to change the ASCII representation of the user data string in order to achieve better energy matching. This could be implemented, for example, by performing the above-described energy matching calculation for every combination of different ASCII representations for a given user data string.

Although the specific embodiment has been described with reference to methods of incorporating user data strings into media files, it should be appreciated that one way such methods can be provided is as an article of manufacture comprising a programmed memory, e.g., a programmed storage medium having computer readable program code, for example, for use on general purpose computing systems.

Those skilled in the art, however will appreciate that the invention is not limited to use only with the ‘WHAT’ command but is equally applicable to other general purpose scan facilities. Additionally, the invention is not limited to use with media files, and can be used with any substantially error-tolerant files.

Furthermore, the implementation of the above-described techniques is not limited for use with the post-processing of files. For example, the same techniques can also be included with media file generation and editing applications, for directly embedded user data strings into such files.

1. A method of incorporating a data sequence in a media file, wherein the data sequence comprises an identification sequence bounded by predetermined delimiters, comprising:
determining a position where the data sequence can be incorporated into the file so as to take into account the human perception of the incorporated data sequence upon playback or viewing of the file; and
incorporating the data sequence at the determined position in such a way as to enable the subsequent output of the identification sequence by a general purpose scan facility capable of recognizing the delimiters and that can output the identification sequence irrespective of the file format or file contents outside of the delimiters.

2. The method of claim 1, wherein the step of incorporating the data sequence includes replacing data in the file with the data sequence.

3. The method of claim 2, wherein the step of determining the position comprises: calculating, for each position in the file, the energy difference of the data sequence to be incorporated and the corresponding file data to be replaced.

4. The method of claim 3, wherein the step of determining further comprises: modifying the identification sequence to be incorporated in such a way as to change the binary value of the data sequence without changing the information conveyed thereby; and
calculating, for the modified data sequence, and for each position in the file, the energy difference of the modified data and the corresponding data to be replaced in the file.

5. The method of claim 1, wherein the general purpose scan facility is the ‘WHAT’ command, and wherein the delimiting sequences comprise at least one of the ASCII sequences: @(#), ″, > and new-line.

6. The method of claim 1, wherein the media files are substantially error-tolerant.

7. The method of claim 1, wherein the media file is an audio file.

8. The method of claim 1, wherein the media file is an image file.

9. A method of embedding a data sequence into a file, comprising choosing the position where the data sequence is to be embedded in the file by taking into account human perception of the presence of the embedded data, the embedded data sequence being clearly identifiable within binary data of the file in such a way so as to allow a general purpose scan facility to subsequently extract the data sequence from the file.

10. The method of claim 1 further including causing a general purpose scan facility to respond to the file including the incorporated data sequence and (a) recognize the delimiters and (b) output the identification sequence irrespective of the file format or file contents outside the recognized delimiters.

11. The method of claim 10 causing the general purpose scan facility to subsequently extract and identify the data sequence from the file.

12. A method of post-processing a substantially error-tolerant media file to incorporate a data sequence into the file, wherein the data sequence includes an identification sequence bounded by predetermined delimiters, comprising:
determining a position where the data sequence can be incorporated into the file so as to take into account the human perception of the incorporated data sequence upon playback or viewing of the file; and
incorporating the data sequence at the thereby determined position in such a way as to enable a general purpose scan facility to subsequently output the identification sequence, the general purpose scan facility being capable of recognizing the delimiters, and outputting the identification sequence irrespective of the file format or file contents outside of the delimiters.

13. The method of claim 12, wherein the step of incorporating the data sequence includes replacing existing data in the file with the data sequence.

14. The method of claim 13, wherein the step of determining the position comprises: calculating, for each position in the file, the energy difference of the data sequence to be incorporated and the corresponding file data to be replaced.

15. The method of claim 14 wherein the energy for each file position is calculated in accordance with:
E=(xᵢ−w₀)²+(xᵢ₊₁−w₁)² . . . +(xᵢ₊ₙ−wₙ)² 0<i<Filesize−n
where:
E=approximation of total energy difference
Xᵢ=the value of byte i in the file
Wᵢ=the value of byte i in a ‘WHAT’ string

16. The method of claim 14, wherein the step of determining further comprises: modifying the identification sequence to be incorporated in such a way as to change the binary value of the data sequence without changing the information conveyed thereby; and calculating, for the modified data sequence and for each position in the file, the energy difference of the modified data and the corresponding data sequence to be replaced in the file.

17. The method of claim 12, further including causing the general purpose scan facility to be responsive to a ‘WHAT’ command to be supplied to it.

18. The method of claim 12 further including causing a general purpose scan facility to respond to the file including the incorporated data surface and (a) recognize the delimiters and (b) output the identification sequence irrespective of the file format or file contents outside the recognized delimiters.

19. A memory storing a computer readable program code for causing a computer to: incorporate a data sequence in a media file, wherein the data sequence comprises an identification sequence bounded by predetermined delimiters, the computer readable program code including: computer readable program code for causing a computer to (a) determine a position where the data sequence can be incorporated into the file so as to take into account the human perception of the incorporated data sequence upon playback or viewing of the file, and (b) incorporate the data sequence at the determined position in such a way as to enable the subsequent output of the identification sequence by a general purpose scan facility capable of recognizing the delimiters and that can output the identification sequence irrespective of the file format or file contents outside of the delimiters.

20. A method of incorporating a data sequence in a media file, wherein the data sequence comprises an identification sequence bounded by predetermined delimiters, comprising:
determining a position where the data sequence can be incorporated into the file by replacing existing data in the file, the position being determined by calculating for each position in the file the energy difference of the data sequence and the corresponding data to be replaced in the file, so as to take account the human perception of the incorporated data sequence upon playback or viewing of the file; and
incorporating the data sequence at the determined position in such a way as to allow the subsequent output of the identification sequence by a general purpose scan facility capable of (a) recognizing the delimiters and (b) outputting the identification sequence irrespective of the file format or file contents outside of the delimiters.
